(19) United States
(12) Patent Application Publication
(10) Pub. No.: US 2015/0195515 A1
(43) Pub. Date: Jul. 9, 2015

(54) IMAGE DISPLAY APPARATUS, DRIVING METHOD THEREOF, AND IMAGE DISPLAY METHOD

(71) Applicant: SAMSUNG ELECTRONICS CO., LTD., Suwon-si (KR)

(72) Inventor: Chul-mok LEE, Hwaseong-si (KR)

(73) Assignee: SAMSUNG ELECTRONICS CO., LTD., Suwon-si (KR)

(21) Appl. No.: 14/510,511

(22) Filed: Oct. 9, 2014

(30) Foreign Application Priority Data
Jan. 9, 2014 (KR) 10-2014-0002791

(51) Int. Cl. H04N 13/04; H04N 21/81; H04N 21/422; H04N 13/00

(52) U.S. Cl. CPC H04N 13/0454; H04N 13/0051; H04N 13/045; H04N 13/0497; H04N 13/0429; H04N 21/816; H04N 21/42206

(57) ABSTRACT

An image display apparatus including an interface configured to receive a first control command from a first remote control apparatus and a second control command from a second remote control apparatus, an image processor configured to process a first content image corresponding to the received first control command and a second content image corresponding to the received second control command, a display, and a controller configured to, in response the first control command being received from the first remote control apparatus, control the image processor to process the first content image and control the display to display the processed first content image, in response to the second control command viewing being received from the second remote control apparatus while the processed first content image is displayed, control the image processor to process the second content image and control the display to display the processed first content image and the processed second content image in a multi-view viewing mode.

### CROSS-REFERENCE TO RELATED APPLICATIONS

This application claims priority from Korean Patent Application No. 10-2014-0002791, filed on Jan. 9, 2014 in the Korean Intellectual Property Office, the disclosure of which is incorporated herein by reference in its entirety.

### BACKGROUND

1. Field

Apparatuses and methods consistent with exemplary embodiments relate to an image display apparatus, a driving method thereof, and an image display method, and more particularly, to an image display apparatus which determines multi-view and realizes multi-view images according to whether a plurality of users give a control command through for example different remote controls, and a driving method and an image display method thereof.

2. Description of the Related Art

In general, a multi-view function of a broadcast receiving apparatus enables two or more people to control or manipulate different broadcasts or applications. In order to use the multi-view function, general users activate the multi-view function using a menu or a setting application of the broadcast receiving apparatus, and control it using a remote control. In order to cancel the multi-view function, users use the menu or the setting application of the broadcast receiving apparatus again, or use a multi-view cancel shortcut button provided on the remote control.

In the related art, in order to drive or cancel the multi-view function, cumbersome processes such as using the menu or the setting application or using the shortcut button are required as described above.

In addition, whenever using the multi-view function, users have to set the channel or volume repeatedly.

### SUMMARY

One or more exemplary embodiments overcome the above disadvantages and other disadvantages not described above. However, exemplary embodiments are not required to overcome the disadvantages described above, and one or more exemplary embodiments may not overcome any of the problems described above.

One or more exemplary embodiments provide an image display apparatus which determines multi-view and realizes multi-view images according to whether a plurality of users give a control command through for example different remote controls, and a driving method and an image display method thereof.

According to an aspect of an exemplary embodiment, there is provided an image display apparatus including an interface configured to receive a first control command from a first remote control apparatus and a second control command from a second remote control apparatus, an image processor configured to process a first content image corresponding to the received first control command and a second content image corresponding to the received second control command, a display, and a controller configured to, in response the first control command being received from the first remote control apparatus, control the image processor to process the first content image and control the display to display the processed first content image, and, in response to the second control command being received from the second remote control apparatus while the processed first content image is displayed, control the image processor to process the second content image and control the display to display a the processed first content image and the processed second content image in a multi-view viewing mode.

The image display apparatus may further include a storage configured to store a setting value regarding the multi-view viewing mode for each remote control apparatus and update the stored setting value. The controller may control the image processor to process the first content image and the second content image based on the updated setting value.

The setting value may include at least one of two-dimensional (2D) and three-dimensional (3D) information, channel information, and volume information.

A number of the control commands may be the same as a number of the processed content images.

The controller may preset and use apparatus information of the first and second remote control apparatuses by a pairing process.

The controller may identify the first remote control apparatus and the second remote control apparatus, and enter multi-view viewing mode in response to a power-on command being received from the second remote control apparatus while the image display apparatus is paired with the first remote control apparatus.

The controller may additionally determine whether a signal is received from 3D glasses in order to determine a format of the multi-view viewing, and when it is determined that a signal is received from the 3D glasses, the controller may control the image processor to process and the display to display a 2D image and a 3D image together on a screen of the display.

According to an aspect of another exemplary embodiment, there is provided a method of driving an image display apparatus includes receiving a first control command from a first remote control apparatus, processing a first content image corresponding to the received first control command, displaying the processed first content image, and in response to receiving a second control command from a second remote control apparatus while the processed first content image is displayed, processing a second content image corresponding to the received second control command and displaying the first and the second processed content images in a multi-view viewing mode.

The method may further include storing a setting value regarding the multi-view viewing mode for each user and update the stored setting value. In the operation of processing the content images, the first content image and the second content image may be processed based on the updated setting value.

The setting value may include at least one of two-dimensional (2D) and three-dimensional (3D) information, channel information, and volume information.

The number of the control commands may be identical to the number of the processed content images.

The method may further include presetting apparatus information of the first and second remote control apparatuses by a pairing process.

The method may further include identifying the first remote control apparatus and the second remote control apparatus may be identified, and in response to a power-on command being received from the second remote control apparatus while the image display apparatus is paired with the first remote control apparatus, the multi-view viewing mode may be entered.

The method may further include determining whether a signal is received from 3D glasses in order to determine a format of the multi-view viewing mode, and in response to it being determined that a signal is received from the 3D glasses, processing and displaying the first content image and the second content image as a 2D image and a 3D image together on a screen.

According to an aspect of another exemplary embodiment, there is provided an image display method including displaying a first content image corresponding to a first control command received from a first remote control apparatus on a screen, and in response to receiving a second control command from a second remote control apparatus while the first content image is displayed, displaying the first content image and a second content image corresponding to the first control command and the second control command, respectively, in a multi-view viewing mode.

In the displaying the first content image and the second content image in the multi-view viewing mode, the screen may be spatially divided so that the plurality of content images are displayed separately.

In the displaying the first content image and the second content image in the multi-view viewing mode, the plurality of content images may be displayed separately in a time division method.

At least one of the first content image and the second content image may be a 3D image.

The first content image and the second content image may be displayed based on previous viewing information of users who previously used the first remote control apparatus and the second remote control apparatus.

The previous viewing information may include at least one of two-dimensional (2D) and three-dimensional (3D) information, channel information, and volume information.

According to an aspect of another exemplary embodiment, there is provided an image display apparatus including an interface configured to receive a plurality of control commands corresponding to a plurality of user apparatuses; a display; and a controller configured to, in response to receiving the plurality of control commands, control the display to display a plurality of content images corresponding to the plurality of control commands in a multi-view viewing mode.

The controller may be further configured to, while the plurality of content images are displayed on the display in the multi-view viewing mode, control the display to display the plurality of content images using at least one among a time division method, a spatial division method, a chromatic division method, and a polarization division method.

The image display apparatus may further include a storage configured to store a plurality of setting values regarding the multi-view viewing mode corresponding to respective user apparatuses among the plurality of user apparatuses. The controller may be further configured to control the display to display the plurality of content images based on the respective setting values.

The controller may be further configured to control the display to display the plurality of content images in multi-view viewing mode without the use of a menu.

According to yet another aspect of the one or more exemplary embodiments, an image display method of a display apparatus includes, in response to receiving the plurality of control commands corresponding to a plurality of user apparatuses, displaying a plurality of content images corresponding to the plurality of control commands in a multi-view viewing mode.

The displaying the plurality of content images in the multi-view viewing mode comprises displaying the plurality of content images using at least one among a time division method, a spatial division method, a chromatic division method, and a polarization division method.

The display method may further include storing a plurality of setting values regarding the multi-view viewing mode for corresponding to respective user apparatuses among the plurality of user apparatuses. The displaying the plurality of content images in the multi-view viewing mode comprises displaying the plurality of content images based on the respective setting values.

The displaying the plurality of content images in the multi-view viewing mode is accomplished without the use of a menu

### BRIEF DESCRIPTION OF THE DRAWING FIGURES

The above and/or other aspects of one or more exemplary embodiments will be more apparent by describing certain exemplary embodiments with reference to the accompanying drawings, in which:

FIG. 1A illustrates an image display system according to an exemplary embodiment;

FIG. 1B illustrates the image display system as shown in FIG. 1A with a change of the user apparatuses according to an exemplary embodiment;

FIGS. 2A, 2B and 2C illustrate examples of multi-view formats according to exemplary embodiments;

FIG. 3 is a block diagram of a configuration of the image display apparatus shown in FIG. 1A according to an exemplary embodiment;

FIG. 4 is a block diagram of a configuration of the image processor shown in FIG. 3 according to an exemplary embodiment;

FIG. 5 is a flow chart of a driving process of the image display apparatus according to an exemplary embodiment; and

FIG. 6 is a flow chart of an image display method according to an exemplary embodiment of.

### DETAILED DESCRIPTION

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments can be carried out without those specifically defined matters. Also, well-known functions or constructions are not described in detail since they would obscure the invention with unnecessary detail.

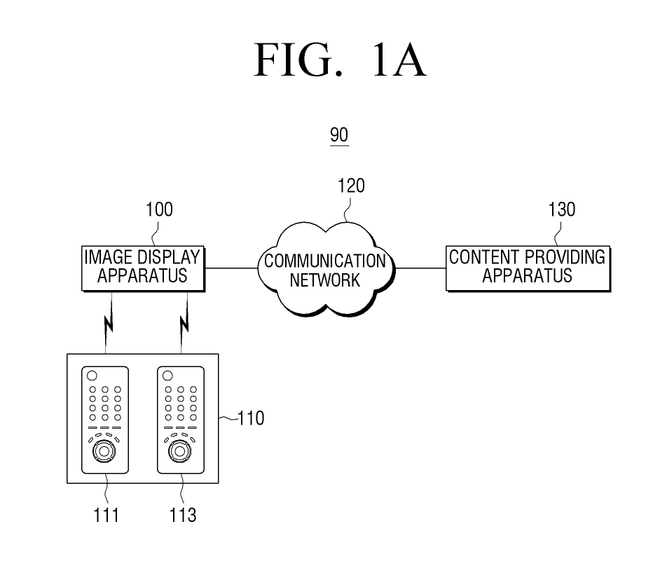

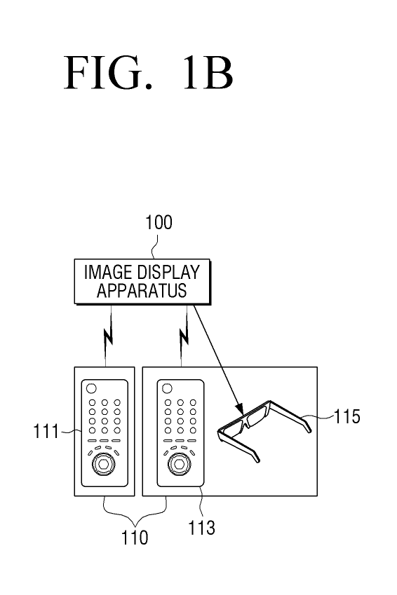

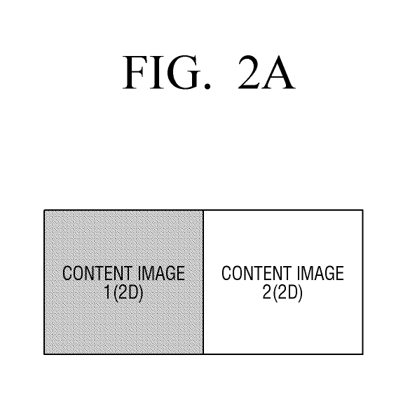

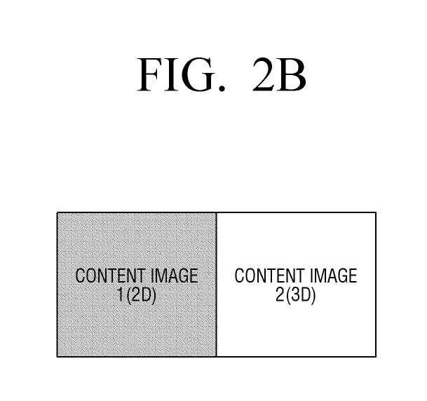

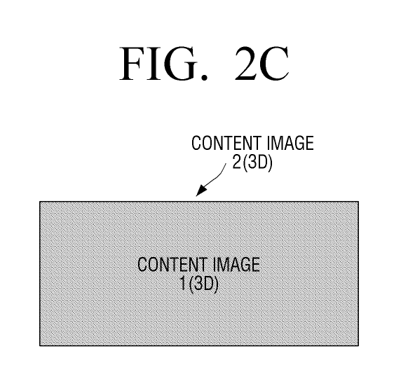

FIG. 1A illustrates an image display system according to an exemplary embodiment, FIG. 1B illustrates the image display system as shown in FIG. 1A with a change according to an exemplary embodiment, and FIGS. 2A, 2B, and 2C illustrate examples of multi-view formats according to exemplary embodiments.

With reference to FIGS. 1A to 2C, the image display system 90 may include an image display apparatus 100, a plurality of user apparatuses 110, a communication network 120, and a content providing apparatus 130.

The image display apparatus 100 may include, as non-limiting examples, a touch screen type image display apparatus (not shown), a spontaneous emission display apparatus such as organic light emitting diodes (OLED) (not shown), or a light receiving display apparatus such as a liquid crystal display (LCD) apparatus (not shown). In addition, the image display apparatus 100 may be, as non-limiting examples, a display apparatus such as a computer, a mobile phone, or television (TV). The light receiving display apparatus may include a separate backlight unit to provide light. The backlight unit may include LEDs.

The image display apparatus 100 determines whether user commands (or control commands) to watch multi-view content are received from a plurality of users, more precisely, from the plurality of user apparatuses 110, and performs a multi-view function according to the determination results. The image display apparatus 100 may assume diverse situations to perform the multi-view function. Above all, in this exemplary embodiment, whether different users give user commands may be considered significant. In other words, the image display apparatus 100 stores viewing information (or a setting value) regarding a content image that a user watches last, and when the user starts watching a different content image, the image display apparatus 100 may utilize the viewing information stored in an internal memory. Of course, when the same user gives user commands through different remote control apparatuses 111 and 113, the multi-view viewing is possible.

More specifically, in order to realize the multi-view, the image display apparatus 100 may perform pairing process with the plurality of user apparatuses 110 first. In other words, through the pairing process, the plurality of user apparatuses 110 are registered as objects to control the image display apparatus 100. To do so, when remote control apparatus 1 (111) requests registration of use, the image display apparatus 100 approves the request and stores apparatus information regarding remote control apparatus 1 (111). Remote control 2 (113) also performs the same registration process. Subsequently, when remote control apparatus 1 (111) gives a user command to watch content image 1, and remote control apparatus 2 (113) also gives a user command to watch content image 2, the image display apparatus 100 determines this situation and performs the multi-view function.

For example, in response to receiving a power-on request from remote control apparatus 1 (111), the image display apparatus 100 may be powered and display on the screen a content image most recently watched using remote control apparatus 1 (111). Subsequently, in response to receiving a power-on request from remote control apparatus 2 (113), the image display apparatus 100 may display on the screen a content most recently watched using remote control apparatus 2 (113), and display content image 1 and content image 2 as multi-view.

In this exemplary embodiment, when receiving power-on requests from remote control apparatus 1 (111) and remote control apparatus 2 (113), the image display apparatus 100 determines multi-view. However, it is possible for the image display apparatus 100 to determine multi-view by using other function buttons, or according to how a power button of the image display apparatus 100 is pressed, such as a press and hold, instead of using the plurality of user apparatuses 110. Diverse methods may be used according to an initially set method. Above all, in this exemplary embodiment, any method is allowable if cumbersome process of the related art such as calling a menu to set multi-view viewing may be omitted. In other words, it is preferable to simply use an external button of the image display apparatus 100 or buttons of remote control apparatuses 1 and 2 (111 and 113).

In addition, the image display apparatus 100 may realize diverse types of images according to what types of user apparatuses 110 are used. In other words, when the plurality of remote control apparatuses 1 and 2 (111 and 113) are used as shown in FIG. 1A, two-dimensional (2D) images may be simply displayed as shown in FIG. 2A. When the user who uses remote control apparatus 2 (113) wears user glasses 115 or turn on the user glasses 115 as shown in FIG. 1B, a 2D image and a three-dimensional (3D) image may be displayed as shown in FIG. 2B. In addition, it is possible for a plurality of users to watch 3D images of different contents by time division as shown in FIG. 2C.

During this process, the image display apparatus 100 may display images in diverse methods according to what content images the users watch last using remote control apparatus 1 (111) and remote control apparatus 2 (113), and according to in what implementation method the users watch the corresponding images. For example, when a user watches a broadcast program on channel 7 using remote control apparatus 1 (111) in 2D and adjusts the volume to 11, the image display apparatus 100 stores these conditions as viewing information of the user. When the image display apparatus 100 receives a viewing request from remote control apparatus 1 (111) again, the image display apparatus 100 displays an image on the screen based on the viewing information. If the user watched a 3D image most recently, when the image display apparatus 100 does not receive any signal from the user glasses, the image display apparatus 100 may display an image based on viewing information regarding a 2D image that the user watched last, or the image display apparatus 100 may convert the lastly watched 3D image into a 2D image and display the converted 2D image.

The plurality of user apparatuses 110 may be referred to as a user apparatus unit. The plurality of user apparatuses 110 may include remote control apparatuses 1 and 2 (111 and 113) as shown in FIG. 1A, and may further include the user glasses 115 as shown in FIG. 1B. Other diverse alterations may be applied. Remote control apparatuses 1 and 2 (111 and 113) may be used after performing separate pairing process in order to control the image display apparatus 100. If remote control apparatuses 1 and 2 (111 and 113) are compatible with the image display apparatus 100, the separate pairing process may be omitted. Although two user apparatuses 111 and 113 are shown, this is merely exemplary, and the plurality of user apparatuses 110 may include 3 or more user apparatuses.

In addition, the plurality of user apparatuses 110 may determine a button to be used as a function button for multi-view operation while performing the pairing process with the image display apparatus 100. For example, in this exemplary embodiment, it has been assumed that multi-view is implemented using the power button. However, the plurality of user apparatuses 110 are paired when the image display apparatus 100, the image display apparatus 100 may set a different button of the plurality of user apparatuses 110 to be a button to request multi-view viewing. Accordingly, it is possible to perform multi-view viewing using any user apparatus.

The communication network 120 may include wired and/or wireless communication networks. The wired network may include a cable network, and an internet network such as a public switched telephone network (PSTN). The wireless network may include code division multiple access (CDMA), wideband CDMA (WCDMA), global system for mobile communication (GSM), evolved packet core (EPC), long term evolution (LTE), wireless broadband internet (WiBro) networks. When the communication network 120 is a wired communication network, an access point may access a telephone exchange office, or when the communication network 120 is a wireless communication network, an access point may process data by accessing a serving general packet radio service (GPRS) support node (SGSN) or a gateway GPRS support node (GGSN) which is operated by a mobile carrier or may process data by accessing diverse repeaters such as base station transmission (BTS), NodeB, e-NodeB, and the like.

In addition, the communication network 120 may include a small base station (AP) (not shown) such as femto and pico base stations which are installed mostly in a building. The femto base station and pico base station are distinguished according to how many image display apparatuses 100 can access the base station. The AP includes a local area communication module to perform local area communication, such as Zigbee and wireless fidelity (Wi-Fi), with the image display apparatus 100. In one or more exemplary embodiments, the local area communication may be performed in diverse standards of radio frequency (RF) and ultra wideband (UWB) communication such as Bluetooth, Zigbee, IrDA, ultra high frequency (UHF), and very high frequency (VHF) as well as wireless fidelity (Wi-Fi). Accordingly, the AP extracts a location of a data packet, sets an optimal communication path for the extracted location, and transmits the data packet to a subsequent apparatus, for example, to the image display apparatus 100 along the set communication path.

The content providing apparatus 130 includes a broadcasting server operated by a broadcasting station. In addition, the content providing apparatus 130 may include a server of an image content provider which provides diverse image contents.

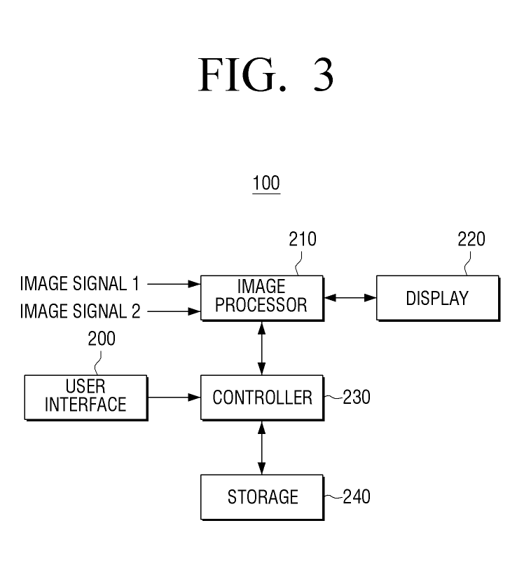

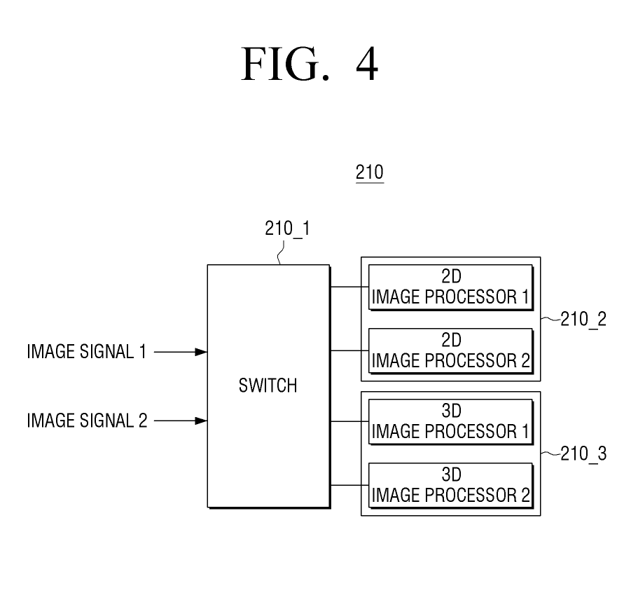

FIG. 3 is a block diagram of a configuration of the image display apparatus 100 shown in FIG. 1A according to an exemplary embodiment, and FIG. 4 is a block diagram of a configuration of the image processor 210 shown in FIG. 3 according to an exemplary embodiment.

With reference to FIGS. 3 and 4 together with FIG. 1A, the image display apparatus 100 may include, in part or in whole, a user interface 200, an image processor 210, a display 220, a controller 230, and a storage 240.

Including the components in part or in whole indicates excluding some components such as the storage 240, integrating some components such as the image processor 210 into another component such as the controller 230, or including additional components not shown. For sufficient understanding of the invention, let's assume that the image display apparatus 100 includes all of the components.

The user interface 200 receives a user command from the plurality of user apparatuses 110 shown in FIG. 1, and transmits the user command to the controller 230. The user command may generate diverse signals such as a power-on/off signal, a channel change signal, and a volume control signal.

The image processor 210 processes an input image signal and outputs the processed image signal to the display 220. The image processor 210 may include a 2D image processor 210_2 to process a 2D image, and a 3D image processor 210_3 to process a 3D image, as shown in FIG. 4. The 2D image processor 210_2 and the 3D image processor 210_3 each may include a plurality of sub image processors. Accordingly, the image processor 210 may include a switch 210_1 to select a sub image processor.

For example, when the controller 230 receives a user command and determines that the display 220 is spatially divided to display two 2D content images separately, the image processor 210 may drive both 2D image processors 1 and 2 in the 2D image processor 210_2. When a 2D content image and a 3D content image are displayed, the image processor 210 may drive one of 2D image processors 1 and 2 in the 2D image processor 210_2, and one of 3D image processors 1 and 2 in the 3D image processor 210_3. During this process, the 3D image processor 210_3 may process an input 3D image and output the 3D image as it is, or may convert an input 2D image into a 3D image and output the 3D image. Accordingly, in this exemplary embodiment, how to generate an image in order to implement multi-view is not limited. For example, the image processor 210 may designate an input 2D image as a left-eye image, and generate a right-eye image by shifting the left-eye image using acquired depth information. Further, although in this exemplary embodiment, two image processors 210_2 and 210_3 are illustrated, this is merely an example, and the image processor 210 may include only a single image processor or three or more image processors may be used. Further although in this exemplary embodiment two sub-image processors are illustrated for each image processor 210_2 and 210_3, this is merely an example, and an image processor may include only a single sub-image processor or three or more sub-image processors.

The display 220 may implement multi-view by spatially dividing the screen, or may implement multi-view of two 2D or 3D images by time division. For example, when an image of 60 frames per 1 second is implemented, 30 frames implement content image 1 in 2D or 3D, the remaining 30 frames implement content image 2 in 2D or 3D. Content images 1 and 2 may be implemented alternately. For example, in the case of 3D images, a left-eye image and a right-eye image for one frame of content image 1 are displayed, and subsequently a left-eye image and a right-eye image for one frame of content image 2 are displayed. However, these implementations are merely examples and the display 220 may implement multi-view of two 2D or 3D images through other means, such as chromatic division, polarization, or a combination of any of the techniques.

The controller 230 controls overall operations of the user interface 200, the image processor 210, and the storage 240 in the image display apparatus 100. In other words, in response to receiving a user command from the user interface 200, the controller 230 analyzes (or determines) the user command and determines whether to perform the multi-view viewing. For example, when user A gives a power-on command to the image display apparatus 100 and subsequently user B gives a power-on command to the same image display apparatus 100, the controller 230 determines whether to perform multi-view viewing based on this situation. Apparatus information of user apparatuses which are used by users A and B may be preset in the image display apparatus 100, and may be stored as different apparatus information. The apparatus information may be apparatus information of the remote control apparatuses 1 and 2 (111 and 113) shown in FIG. 1.

When multi-view viewing is requested, the controller 230 controls the image processor 210. As described above with the image processor 210, the controller 230 determines whether multi-view viewing is requested, and the controller 230 controls the image processor 210 to implement multi-view viewing with reference to previous viewing information of the user according to the determination results. For example, when a user requests the image display apparatus 100 to implement 2D but previous viewing information relates to 3D implementation, the controller 230 may control the image processor 210 with reference to viewing information regarding 2D implementation earlier than the previous viewing information.

The storage 240 may store information processed by the image display apparatus 100 under the control of the controller 230. For example, when a power-on command is received from the remote control apparatus 1 (111) through the user interface 200, the storage 240 stores information regarding the received power-on command, and when a power-on command is received from remote control apparatus 2 (113) through the user interface 200, the storage 240 stores information regarding the received power-on command. Subsequently, when the controller 230 requests the information, the storage 240 provides the stored information regarding the user command. In addition, the storage 240 stores viewing information of each user received through the user interface 200, and updates the stored viewing information. The viewing information of each user may be viewing information provided using each of the remote control apparatuses 1 and 2 (111 and 113). For example, when a user watches a broadcast program on channel 7 using the remote control apparatus 1 (111) in 3D and adjusts the volume to 11, the storage 240 stores these conditions as viewing information of the user. The viewing information may include other diverse information.

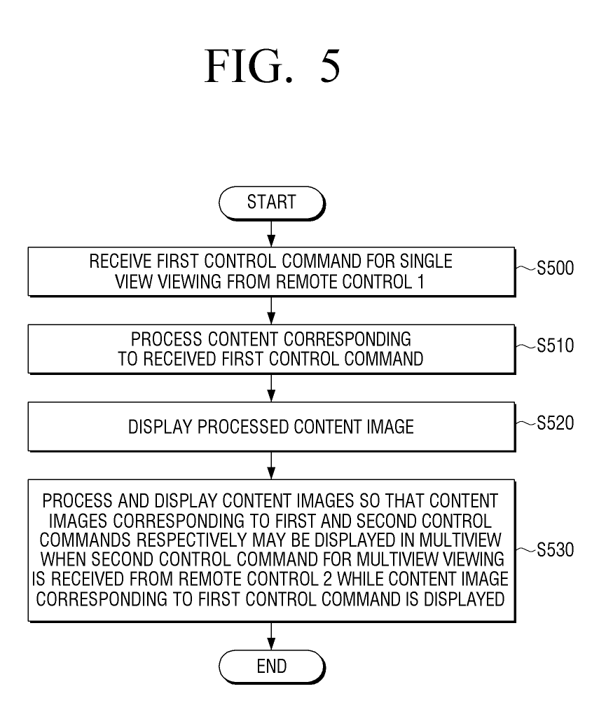

FIG. 5 is a flow chart of a driving process of the image display apparatus 100 according to an exemplary embodiment.

With reference to FIG. 5 together with FIG. 1 for convenient description, the image display apparatus 100 receives a first control command for single view viewing from the remote control apparatus 1 (111) (S500). The first control command may be a command given by pressing the power button of remote control apparatus 1 (111).

Subsequently, the image display apparatus 100 processes content corresponding to the received first control command (S510). To do so, the image display apparatus 100 may use user viewing information, which is stored in the internal memory, regarding a program that the user of the remote control apparatus 1 (111) watched last, or may process content of a channel selected by the user. Processing the content includes demultiplexing, scaling, and the like.

Subsequently, the image display apparatus 100 displays the processed content image on the screen (S520).

Subsequently, when the image display apparatus 100 receives a second control command for multi-view viewing from remote control apparatus 2 (113) while displaying the content image corresponding to the first control command, the image display apparatus 100 processes and displays content images so that the plurality of content images corresponding to the first and second control commands respectively may be displayed in multi-view (S530). The second control command may be a command given by pressing the power button of remote control apparatus 2 (113). Although in FIG. 5 the second control command is received after the processed content corresponding to the first control command is displayed, this is merely an example, and the second control command may be received before any of the previous steps.

More specifically, the image display apparatus 100 may receive a plurality of user commands, that is to say control commands, for multi-view viewing. The user commands may be user commands having the same characteristics. The user commands having the same characteristics may be a power-on command of remote control apparatus 1 (111) shown in FIG. 1, and a power-on command of remote control apparatus 2 (113). In addition, the user commands may be user commands having the same characteristics which are given by different apparatuses. The same characteristics indicate commands to perform the same function. Although in this exemplary embodiment the image display apparatus 100 may receive a plurality of user commands using only the power button of the image display apparatus 100, one or more exemplary embodiments are not limited to the above description. In other words, when the power button of the image display apparatus 100 is pressed once and is pressed again, the image display apparatus 100 may determine whether the second pressing is a user command for multi-view viewing or a user command to turn off the image display apparatus 100 by, for example, determining a period of time being pressed during the second pressing.

Subsequently, the image display apparatus 100 determines multi-view viewing based on the plurality of user commands. For example, when user commands having the same characteristics are received from different user apparatuses, the image display apparatus 100 may determine that the user commands wish multi-view viewing. However, since there may be diverse methods for determining multi-view viewing, one or more exemplary embodiments are not limited to determining multi-view viewing using the power button.

In addition, the image display apparatus 100 processes content images for multi-view viewing according to the determination results. In other words, as a non-limiting example, when viewing information of a program that a user watched last using the remote control apparatus 1 (111) shown in FIG. 1 is channel 7, 2D broadcasting, and volume 11, and when viewing information of a program that a user watched last using the remote control apparatus 2 (113) shown is channel 9, 3D broadcasting, and volume 11, content images are processed to implement 2D broadcasting on channel 7 and 3D broadcasting on channel 9 based on the last viewing information. On the two channels, the volume is set to 11.

Accordingly, the image display apparatus 100 displays the content images processed for multi-view on the screen. In the above example, a 2D image and a 3D image are displayed on the screen.

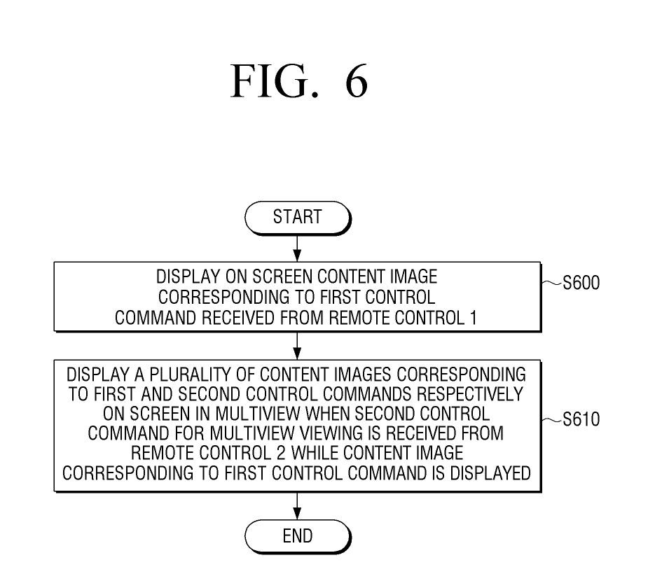

FIG. 6 is a flow chart of an image display method according to an exemplary embodiment.

With reference to FIG. 6 together with FIG. 1 for convenience of description, the image display apparatus 100 displays on the screen a content image corresponding to a first control command received from remote control apparatus 1 (111) (S600).

Subsequently, when the image display apparatus 100 receives a second control command for multi-view viewing from remote control apparatus 2 (113) while displaying the content image corresponding to the first control command, the image display apparatus 100 displays a plurality of content images corresponding to the first and second control commands respectively on the screen in multi-view (S610).

More specifically, the image display apparatus 100 displays a first content image on the screen in single view in accordance with a user command of a first user, more precisely, in accordance with a user command from remote control apparatus 1 (111). The user command may be a power-on command. The single view indicates displaying single content on the screen.

Subsequently, the image display apparatus 100 determines whether a user command for multi-view viewing is received from a second user. For example, when the image display apparatus 100 receives a power-on command from remote control apparatus 2 (113), the image display apparatus 100 determine that the user wants multi-view viewing.

Subsequently, when the image display apparatus 100 determines that the user command for multi-view viewing is received from the second user, the image display apparatus 100 implements the first content image for the first user and the second content image for the second user in multi-view and displays them on the screen.

When implementing the multi-view, the image display apparatus 100 may implement the first content image and the second content image based on viewing information regarding the last broadcasting program watched by the first user and by the second user, more precisely, using the remote control apparatus 1 (111) and using remote control apparatus 2 (113), respectively. Since detailed description has been provided above, further description is not repeated.

In addition, when being paired with the remote control apparatuses 111 and 113, the image display apparatus 100 identifies the remote control apparatuses 111 and 113, determines users based on identified information, and displays a plurality of contents based on setting values stored according to the users in a multi-view viewing mode.

Although the components of one or more exemplary embodiments are described to be combined into one or to be operated by combination, one or more exemplary embodiments are not limited thereto. Within the scope of the purpose of one or more exemplary embodiments, one or more components may be selectively combined and operated. In addition, each of the components may be implemented with independent hardware, or a portion of or all of the components may be selectively combined and be implemented with a computer program having a program module which performs a portion of or all of the functions combined in one or more pieces of hardware. The codes and the code segments which compose the computer program may easily be inferred by those skilled in the art. The computer program is stored in a non-transitory computer readable medium, and is read and run by a computer, a processor, or a controller so that one or more exemplary embodiments may be implemented.

The non-transitory computer readable medium is a medium which does not store data temporarily such as a register, cash, and memory but stores data semi-permanently and is readable by devices. More specifically, the computer program may be stored in non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image display apparatus comprising:
an interface configured to receive a first control command from a first remote control apparatus and a second control command from a second remote control apparatus;
an image processor configured to process a first content image corresponding to the received first control command and a second content image corresponding to the received second control command;
a display; and
a controller configured to, in response the first control command being received from the first remote control apparatus, control the image processor to process the first content image and control the display to display the processed first content image, and, in response to the second control command being received from the second remote control apparatus while the processed first content image is displayed, control the image processor to process the second content image and control the display to display the processed first content image and the processed second content image in a multi-view viewing mode.

2. The image display apparatus as claimed in claim 1, further comprising:
a storage configured to store a setting value regarding the multi-view viewing mode for each remote control apparatus and update the stored setting value,
wherein the controller is further configured to control the image processor to process each of the first content image and the second content image based on the updated setting value.

3. The image display apparatus as claimed in claim 2, wherein the setting value comprises at least one of two-dimensional (2D) and three-dimensional (3D) information, channel information, and volume information.

4. The image display apparatus as claimed in claim 1, wherein a number of the control commands is the same as a number of the processed content images.

5. The image display apparatus as claimed in claim 1, wherein the controller is further configured to preset and use apparatus information of the first and second remote control apparatuses by a pairing process.

6. The image display apparatus as claimed in claim 1, wherein the controller is further configured to identify the first remote control apparatus and the second remote control apparatus, and enter the multi-view viewing mode in response to a power-on command being received from the second remote control apparatus while the image display apparatus is paired with the first remote control apparatus.

7. The image display apparatus as claimed in claim 5, wherein the controller is further configured to determine whether a signal is received from three-dimensional (3D) glasses in order to determine a format of the multi-view viewing, and in response to determining that the signal is received from the 3D glasses, control the image processor to process and the display to display a two-dimensional (2D) image and a 3D image together on a screen of the display.

8. A method of driving an image display apparatus, the method comprising:
receiving a first control command from a first remote control apparatus;
processing a first content image corresponding to the received first control command;
displaying the processed first content image; and
in response to receiving a second control command from a second remote control apparatus while the processed first content image is displayed, processing a second content image corresponding to the received second control command and displaying the first and the second processed content images in a multi-view viewing mode.

9. The method as claimed in claim 8, further comprising:
storing a setting value regarding the multi-view viewing mode for each remote control apparatus and updating the stored setting value,
wherein in the processing the content images, each of the first content image and the second content image is processed based on the updated setting value.

10. The method as claimed in claim 8, wherein the setting value comprises at least one of two-dimensional (2D) and three-dimensional (3D) information, channel information, and volume information.

11. The method as claimed in claim 8, wherein a number of the control commands is the same as a number of the processed content images.

12. The method as claimed in claim 8, further comprising:
presetting apparatus information of the first and second remote control apparatuses by a pairing process.

13. The method as claimed in claim 12, further comprising:
identifying the first remote control apparatus and the second remote control apparatus; and
in response to a power-on command being received from the second remote control apparatus while the image display apparatus is paired with the first remote control apparatus, entering the multi-view viewing mode.

14. The method as claimed in claim 13, further comprising:
determining whether a signal is received from three-dimensional (3D) glasses in order to determine a format of the multi-view viewing mode, and
in response to determining that the signal is received from the 3D glasses, processing and displaying the first content image and the second content image as a two-dimensional (2D) image and a 3D image together on a screen.

15. An image display method comprising:
displaying a first content image corresponding to a first control command received from a first remote control apparatus on a screen; and
in response to receiving a second control command from a second remote control apparatus while the first content image is displayed, displaying the first content image and a second content image corresponding to the second control command on the screen in a multi-view viewing mode.

16. The method as claimed in claim 15, wherein in the displaying the first content image and the second content image in the multi-view viewing mode, the screen is spatially divided so that the plurality of content images are displayed separately.

17. The method as claimed in claim 15, wherein in the displaying the first content image and the second content image in the multi-view viewing mode, the plurality of content images are displayed separately in a time division method.

18. The method as claimed in claim 15, wherein at least one of the first content image and the second content image is a three-dimensional (3D) image.

19. The method as claimed in claim 15, wherein the first content image and the second content image are displayed based on previous viewing information of users who previously used the first remote control apparatus and the second remote control apparatus.

20. The method as claimed in claim 19, wherein the previous viewing information comprises at least one of two-dimensional (2D) and three-dimensional (3D) information, channel information, and volume information.
